(19) United States
(12) Patent Application Publication
(10) Pub. No.: US 2012/0064475 A1
(43) Pub. Date: Mar. 15, 2012

(54) Orthodontic Brackets Including a Ceramic or Polymer Bracket Base and a Metal Insert Having a Selectively Removable Labial Web Cover

(75) Inventors: Paul E. Lewis, Midvale, UT (US); Dwight P. Schnaitter, Lake City, UT (US)

(73) Assignee: Ultradent Products, Inc., South Jordan, UT (US)

(21) Appl. No.: 13/255,486

(22) PCT Filed: Mar. 11, 2010
(86) PCT No.: PCT/US10/26996

§ 371 Date: Nov. 29, 2011

Related U.S. Application Data
(60) Provisional application No. 61/159,879, filed on Mar. 13, 2009.

(51) Int. Cl. A61C 7/28

(52) U.S. Cl. 433/10

(57) ABSTRACT

Convertible orthodontic brackets (100) of the present invention include a bracket base (102) formed of a ceramic and/or polymeric material (104) and a metal insert (105) defining an arch wire hole or tube received within a slot of the bracket base. The metal insert (105) includes a gingival sidewall (105a), an occlusal sidewall (105b), a lingual bottom wall (105 c), and a selectively removable labial web cover (112) extending between gingival and occlusal sidewalls (105a, 105b). The metal insert (105) may be formed as a single, integral piece of metal, preferably by machining. The metal insert (105) may be formed using stronger metals which are unsuitable for use in metal injection molding processes.

### BACKGROUND OF THE INVENTION

1. The Field of the Invention

The present invention relates to orthodontic brackets. More specifically, the invention relates to convertible orthodontic brackets having a selectively removable cover portion that initially covers the arch wire slot.

2. The Relevant Technology

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct underbites or overbites. For example, orthodontic treatment can improve the patient's occlusion and/or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the bracket slots. The arch wire acts as a template or track to guide movement of the teeth into proper alignment. End sections of the arch wire are typically captured within tiny appliances known as tube brackets or terminal brackets, which are affixed to the patient's bicuspids and/or molars. The remaining brackets typically include open arch wire slots and apply orthodontic forces by means of ligatures attached to the brackets and arch wire (e.g., by means of tie wings on the brackets).

It would be an improvement in the art to provide orthodontic brackets combining improved properties and functionality currently not provided by existing brackets.

### BRIEF SUMMARY OF THE INVENTION

The convertible orthodontic brackets according to the present invention include a ceramic and/or polymeric bracket base that includes an insert receiving slot formed within the base, and a metal insert received within the insert receiving slot of the bracket base. The metal insert includes a lingual bottom wall, a gingival sidewall, an occlusal sidewall, and a selectively removable labial web cover, which surfaces define an arch wire hole or tube. The labial web cover extends between the gingival and occlusal sidewalls of the metal insert. The lingual bottom wall, the gingival and occlusal sidewalls, and the selectively removable labial web cover are advantageously formed as an integral single piece of metal (e.g., by machining).

Providing a metal insert within a polymeric bracket base is advantageous because most, if not all, polymeric materials possess relatively limited strength and resistance to deformation, which characteristics may be important to portions of the bracket base surrounding the arch wire slot. The surfaces defining an arch wire slot should have sufficient strength and deformation resistance to receive forces applied by the arch wire and transmit them to the bracket base and tooth without breaking or deforming. Placing a metal insert within a polymeric bracket base provides this needed strength and deformation resistance.

In the case of ceramic materials, a ceramic bracket base may have sufficient strength and deformation resistance. However, the ceramic material is significantly harder than the metal arch wire such that portions of the metal wire can be worn away over time through continuous contact with the ceramic materials, resulting in the formation of notches within the arch wire as the wire slides within the bracket slots. Such notches can catch on the mesial and distal edges of the bracket slots and interfere with proper application of corrective forces and movement of the teeth. In addition, evidence shows that sliding resistance may be significantly higher when the metal arch wire slides against a ceramic arch wire slot as compared to lower sliding resistance of a metal arch wire against a metal arch wire slot. Providing a metal insert serves to line the arch wire slot with metal surfaces to provide the advantages described above for both polymeric and ceramic bracket bases.

In addition, the metal insert of the inventive bracket includes a selectively removable labial web cover. Such a selectively removable cover allows the practitioner to begin treatment with an arch wire hole or tube bounded on four sides (i.e., labial, gingival, lingual, and occlusal), and thereafter remove the labial web cover part way through treatment. Upon removal of the labial web cover, the initially covered labial side of the arch wire hole is exposed, resulting in a functional arch wire slot. The web cover is advantageously formed as a single integral piece with the rest of the metal insert.

The presence of specific features included within the inventive orthodontic brackets provides a combination of features not currently found in the art. For example, a ceramic bracket base with an integral metal insert including a selectively removable labial web cover provides aesthetic, strength, and wear benefits of a ceramic bracket base, the low sliding friction characteristics of a metal orthodontic bracket, and the ability to convert the bracket from a tube bracket with an arch wire hole to a more conventional bracket having an arch wire slot open on the labial side.

In one embodiment, the metal insert is manufactured by machining a suitable metal material rather than by metal injection molding, as is typically used in the manufacture of orthodontic brackets. In metal injection molding, a metal powder mixed with a binder material is injection molded, followed by sintering to remove the binder and cause the metal particles to partially fuse together. During sintering, the object undergoes shrinkage, the magnitude of which is often unpredictable. Moreover, sintered metal articles are not as strong as machined metal articles. Machining the metal insert rather than metal injection molding allows the use of stronger, more dense metal materials, provides for a stronger and/or smaller finished product, and allows for greater precision and tighter tolerances with regard to bracket dimensions. For example, a machined metal insert is able to provide an arch wire hole (or slot after removal of the labial web cover) having more exacting dimensions than is possible with an arch wire hole or slot defined by metal injection molded surfaces.

The use of stronger metals and providing more precise dimensional tolerances in the region of the arch wire hole allows the metal insert to have sufficient strength with less metal. For example, the metal inserts may preferably be formed of 17-4 and/or 17-7 class stainless steels, which exhibit greater strength and density than classes of stainless steel suitable for use in conventional metal injection molded bracket components. Furthermore, the strength and density of metal objects formed by metal injection molding is further compromised as a result of micro air pockets present within the finished metal body after sintering.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary convertible molar orthodontic bracket according to the present invention;

FIG. 1B is a perspective view of an exemplary convertible bicuspid orthodontic bracket according to the present invention;

FIG. 2A is a cross-sectional view the bracket of FIG. 1A, near a mesial edge of the bracket;

FIG. 2B is a cross-sectional view of the bracket of FIG. 1A, near a distal edge of the bracket;

FIG. 3A is a cross-sectional view of a metal insert and surrounding bracket base portion illustrating an exemplary mechanical retention mechanism for facilitating mechanical retention of the metal insert within the ceramic and/or polymeric bracket base;

FIG. 3B is a cross-sectional view of a metal insert and surrounding bracket base portion illustrating an alternative exemplary mechanical retention mechanism for facilitating mechanical retention of the metal insert within the ceramic and/or polymeric bracket base;

FIG. 3C is a cross-sectional view of a metal insert and surrounding bracket base portion illustrating another alternative exemplary mechanical retention mechanism for facilitating mechanical retention of the metal insert within the ceramic and/or polymeric bracket base;

FIG. 4A is a cross-sectional view of a metal insert and surrounding bracket base portion illustrating an exemplary debonding mechanism for facilitating debonding of the bracket from a tooth once treatment is complete;

FIG. 4B is a cross-sectional view of a metal insert and surrounding bracket base portion illustrating an alternative exemplary debonding mechanism for facilitating debonding of the bracket from a tooth once treatment is complete; and

FIG. 4C is a cross-sectional view of a metal insert and surrounding bracket base portion illustrating another alternative exemplary debonding mechanism for facilitating debonding of the bracket from a tooth once treatment is complete.

### DETAILED DESCRIPTION OF THE PREFERRED EMBODIMENTS

### I. Introduction

The convertible orthodontic brackets according to the present invention include a ceramic and/or polymeric bracket base that includes a slot formed within the base configured to receive a metal insert, and a metal insert received within the slot of the bracket base. The metal insert includes a lingual bottom wall, a gingival sidewall, an occlusal sidewall, and a selectively removable labial web cover, the internal surfaces of which define an arch wire hole or tube. The labial web cover extends between the gingival and occlusal sidewalls of the metal insert. The lingual bottom wall, the gingival and occlusal sidewalls, and the labial web cover may advantageously comprise a single integral piece of metal. Manufacture by machining is particularly preferred, which provides tighter dimensional tolerances and allows stronger more dense metals to be employed compared to manufacturing the metal insert by metal injection molding.

### II. Exemplary Orthodontic Brackets

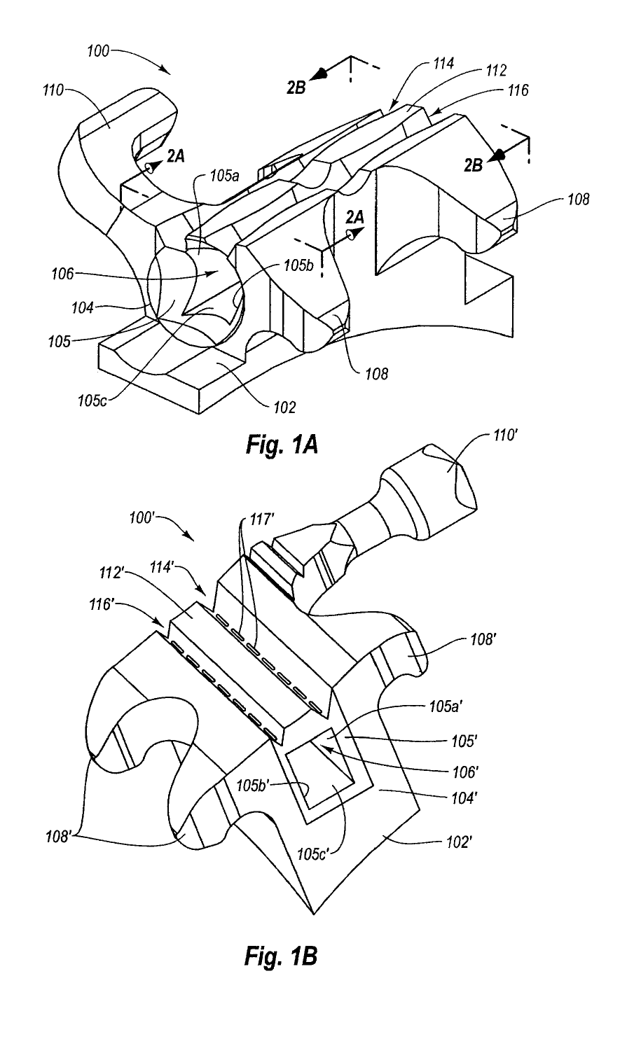

FIGS. 1A-1B illustrate exemplary orthodontic brackets including a ceramic and/or polymeric base and a metal insert having a selectively removable labial web cover received within a slot of the bracket base. FIG. 1A illustrates an exemplary convertible molar tube bracket 100 including a bracket base 102 and body 104 formed of a ceramic and/or polymeric material. Body 104 includes a plurality of tie wings 108, as well as a curved gingival hook 110. A metal insert 105 is received within a labially open slot of body 104. Metal insert 105 includes a gingival sidewall 105a, an occlusal sidewall 105b, a bottom lingual wall 105c, and a selectively removable labial web cover 112, the interior surfaces of which define an arch wire hole 106. As shown, one or both ends of hole 106 may be flared so as to facilitate insertion of an arch wire into hole 106.

As shown, bracket 100 is convertible in the sense that labial web cover 112 of metal insert 105 is selectively removable. The arch wire hole or tube 106 is initially closed on four sides (i.e., labial, lingual, occlusal, gingival) and open at the mesial and distal ends. In the illustrated embodiment, a central thickened portion of labial web cover 112 is bounded by two web regions 114, 116 of reduced cross-sectional thickness interconnecting the thickened central portion of cover 112 with the gingival and occlusal sidewalls 105a, 105b of metal insert 105. By selectively removing labial web cover 112, the practitioner may convert arch wire hole or tube 106 into an arch wire slot that is open along the labial side. Web regions 114, 116 may be substantially parallel to one another, and each web region 114, 116 is formed so as to lie substantially in a respective plane defined by the gingival and occlusal sidewalls 105a, 105b of the metal insert 105 so that no remaining portion of the labial web cover 112 occludes labial access to the arch wire slot once it is removed.

FIG. 1B illustrates an alternative convertible bracket 100′ configured for placement on a bicuspid. Bracket 100′ similarly includes a base 102′ and body 104′ formed of a ceramic and/or polymeric material, as well as a metal insert 105′. Body 104′ further includes tie wings 108′ and a straight gingival hook 110′. Metal insert 105′ is received within a slot of ceramic and/or polymeric body 104. Metal insert 105′ includes a gingival sidewall 105a′, an occlusal sidewall 105b′, a bottom lingual wall 105c′, and a selectively removable labial web cover 112′. The interior surfaces of the walls of metal insert 105′ define an arch wire hole or tube 106′. Labial web cover 112′ extends over arch wire hole 106′, between the gingival and occlusal sidewalls 105a′, 105b′ of metal insert 105′.

Similar to labial web cover 112, labial web cover 112′ is bounded by two web regions 114′, 116′ of reduced cross-sectional thickness, facilitating orderly, predictable, and easy removal of the labial web cover when the practitioner desires. Although illustrated with thinned connecting web regions, one of skill in the art will readily appreciate that additional and/or alternative structures (e.g., perforations) may also be provided along the separable connecting webs 114, 116 and 114′, 116′. FIG. 1B illustrates such an embodiment including thinned web regions 114′, 116′ as well as perforations 117′.

Bracket bases according to the invention may be formed from ceramic or to polymer materials. Exemplary ceramic materials that may be used to form the bracket base include, but are not limited to, aluminum oxide, zirconia, and porcelain. Exemplary polymeric resin materials that may be used to form the bracket base include, but are not limited to, polyamides (e.g., crystalline or amorphous), acetal polymers, polyetherimides, polycarbonates, polyarylether ketones, polysulfones, and polyphenylsulfones.

In both illustrated embodiments, the arch wire hole 106, 106′ defined by the metal insert is closed on four sides when manufactured. The inventive configuration advantageously provides the benefits of a ceramic and/or polymeric orthodontic bracket coupled with the low friction arch wire sliding characteristics of a metal bracket and the convertible characteristics associated with the selectively removable labial web cover. Benefits of ceramic and polymeric materials may include the aesthetics of ceramic or polymeric brackets (e.g., the ability to have a clear or specifically colored bracket), high ceramic strength, high ceramic wear tolerance, and the relative ease of manufacture of inexpensive polymeric brackets. Furthermore, the metal insert which defines the arch wire hole and includes the removable web cover may be formed by machining, resulting in a stronger, more dense metal bracket portion with tighter dimensional tolerances as compared to a bracket formed by metal injection molding.

Machining the metal insert rather than metal injection molding allows use of stronger, more dense metal materials, which materials are not suitable for use in metal injection molding. Use of the stronger, more dense metal materials (e.g., 17-4 and/or 17-7 class stainless steels) provides for a stronger, more dense finished product. In addition, 17-4 and 17-7 class stainless steels may be heat treated after machining to further increase strength. Such heat treatments are not possible using classes of stainless steels suitable for use in metal injection molding. By contrast, metal injection molded bracket components are formed from stainless steel powder materials (e.g., 303, 304, and/or 316L class stainless steels) which, although better suited for powderization and sintering, exhibit less strength and lower density compared to 17-4 and 17-7 class stainless steels. In addition, the strength and density of actual finished bracket components formed by metal injection molding is less than the bulk strength and density of the metal materials employed. That is because micro air pockets can form during molding and sintering, and the strength of the finished article may be further reduced as the sintering process may result in weak particle-to-particle bonding of the metal powder. No such issues occur when machining a bulk metal material.

Furthermore, the dimensional tolerances of the machined arch wire hole as well as the connecting web regions are significantly tighter with machined metal inserts as compared to formation by metal injection molding. For example, when machining the arch wire hole, the dimensions of the arch wire hole are carefully controlled. Tighter dimensional tolerances with respect to the arch wire hole result in a better fit with the arch wire, which results in overall faster treatment times. Such control is simply not possible with metal injection molding, where the sintering process results in an unpredictable amount of shrinkage or other deformation.

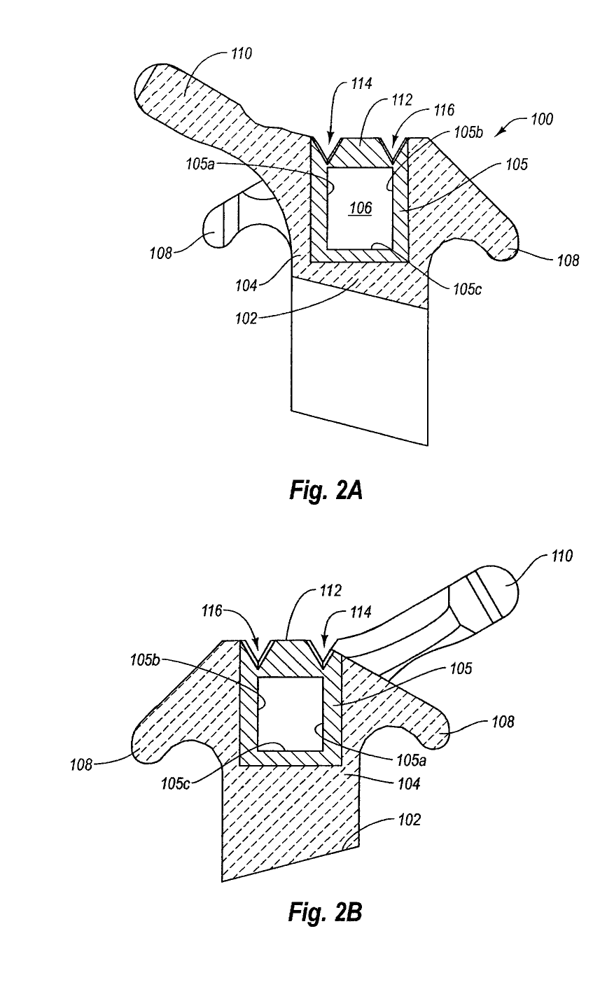

In addition, when the metal inserts are formed by machining, it is possible to form the connecting web regions of the labial web cover so as to include variable thicknesses that change as one moves from the mesial edge towards the distal edge of the connecting web. Such an embodiment is illustrated in FIGS. 2A-2B, which illustrate cross-sections near the mesial edge of bracket 100 and distal edge of bracket 100, respectively. As seen in FIG. 2A, the extreme mesial edge of connecting web regions 114 and 116 may be machined so as to provide a smaller web thickness, facilitating easier removal of the labial web cover starting from the mesial edge. As seen in FIG. 2B, a cross section near the distal edge of connecting web regions 114 and 116 may advantageously be provided with greater thickness, providing an overall level of desired strength to the web cover 112 so as to prevent premature and/or unintentional removal of the web. Greater arch wire forces are typically exerted at the distal end of a molar or bicuspid bracket compared to the mesial end. Providing a variable, tapered thickness as illustrated allows a practitioner to begin peeling at the mesial edge, where web thickness is at a minimum, and continuing towards the thicker distal edge. Such a variable tapered web thickness is difficult, if not a practical impossibility, to form using conventional metal injection molding techniques. For example, such a variable tapered thickness would be impractical with a metal injection molded bracket, as the unpredictable shrinkage associated with the manufacturing process would likely make it difficult or impossible to provide desired dimensional tolerances.

By way of example, the amount of peeling force required to remove the web covers is between about 10 lbs. and about 30 lbs., more preferably between about 12 lbs. and about 28 lbs., and most preferably between about 17 lbs. and about 23 lbs. Commercially available metal injection molded brackets including a removable labial web cover must be batch tested as a result of the inability to provide tight dimensional tolerances relative to web thickness. For example, such batch testing results in rejection of batches in which the web removal force is less than 10 lbs or greater than 30 lbs. As a result, a significant quantity of the manufactured brackets must be discarded. Any attempt to metal injection mold a labial web cover including a variable tapered thickness would be impractical, as the rejection rates would likely be even higher.

Because machining provides for narrower dimensional tolerances, and thus a narrower range of web removal force, intraoral removal of the labial web cover 112, 112′ is less likely to result in debonding of the bracket from the tooth, as might otherwise occur with a metal injection molded labial web cover where the dimensional tolerances (and thus web removal force) vary within a wider range.

By contrast, manufacture by machining allows for significantly improved dimensional tolerances, which tolerances directly affect the force required for web removal. For example, brackets including machined metal inserts could include a much narrower range of force required for web removal (e.g., about 17 lbs. to about 23 lbs.) with little or no rejection rate. Such an improvement would be appreciated by practitioners, as the bracket's performance would be significantly more predictable. Furthermore, the bracket base is formed of ceramic and/or a polymeric material, which provides advantages over all commercially available metal convertible brackets.

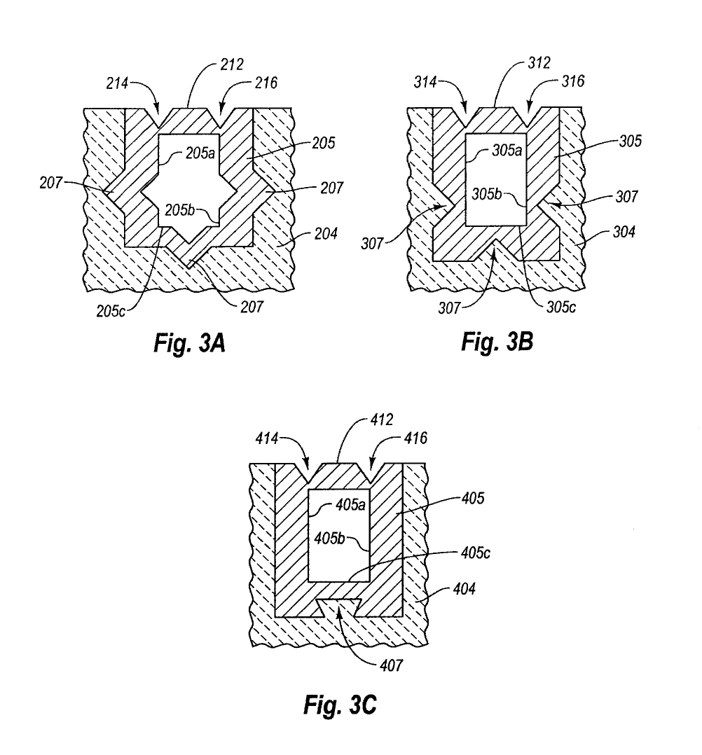

The brackets may advantageously include a mechanism for mechanically retaining the metal insert within the receiving slot of the ceramic and/or polymeric bracket base. Exemplary structures are shown in FIGS. 3A-3C. FIG. 3A illustrates a metal insert 205 including a selectively removable labial web cover 212 bounded on the gingival and occlusal sides by connecting web regions 214, 216. One or more of the gingival sidewall 205a, the occlusal sidewall 205b, or the bottom lingual wall 205c include an outwardly extending projection 207 configured to mate with a corresponding recess formed within the ceramic and/or polymeric bracket body 204. The illustrated embodiment includes a projection 207 formed within each of the gingival, occlusal, and lingual walls 205a, 205b, 205c. Alternatively, the projections may be formed in only one or two of the walls.

FIG. 3B illustrates an alternative metal insert 305 including selectively removable labial web cover 312 bounded by connecting web regions 314, 316. The gingival wall 305a, occlusal wall 305b, and lingual wall 305c each include an exterior recess 307 formed therein, while ceramic and/or polymeric bracket body 304 includes corresponding interiorly extending projection structures for mating with the recesses 307 of the metal insert 305.

FIG. 3C illustrates an embodiment of a metal insert 405 including a labial web cover 412 bounded by connecting web regions 414, 416. Metal insert includes a dovetail recess 407 corresponding to the shape of a dove-tail formed into the lingual bottom wall 405c. Bracket body 404 includes a corresponding interiorly extending dovetail structure for mating with dovetail recess 407. Of course, dovetail or other locking recesses may be formed in one, two, or three of walls 405a, 405b, 405c. Another alternative may include a combination of recesses and projections formed within the gingival, occlusal, and/or lingual walls of the metal insert, with corresponding mating structures formed on the ceramic and/or polymeric bracket body.

The brackets may also advantageously include a mechanism for facilitating debonding of the orthodontic bracket from a tooth once treatment is completed. Such a feature is particularly preferable where the bracket base comprises a ceramic material. Ceramic brackets can be difficult to debond from the teeth, as the ceramic base is prone to fracture, leaving portions bonded to the tooth. The remaining portions must then be removed using a diamond bur, which is time consuming and creates a risk of damage to the underlying tooth structure.

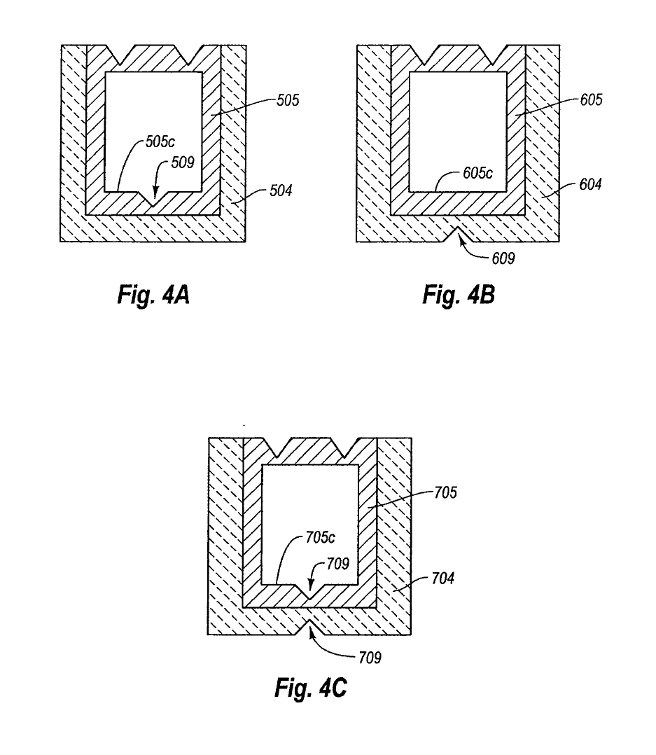

Exemplary debonding facilitating structures are shown in FIGS. 4A-4C. Each illustrated structure includes a centrally disposed region (e.g., preferably along the mesial-distal longitudinal axis of the bracket) on or near the bonding base of the to bracket, which is configured so as to have a reduced cross-sectional thickness. Such placement of a region of reduced cross-sectional thickness forces the bracket to break at a desired location, greatly facilitating easy debonding and removal. For example, FIG. 4A illustrates a metal insert 505 including an interior recess 509 formed near a centerline of the lingual bottom wall 505c of the metal insert. Such a recess results in the overall thickness (and thus strength) of the bottom of the bracket being reduced in this area. In other words, the bottom wall of the bracket (i.e., the bottom wall portion of ceramic body 504 plus lingual bottom wall 505c) includes a localized line of reduced thickness in this area. Preferably, this localized line of reduced thickness extends along a substantial portion of the total longitudinal length of the bracket. Such a recess may extend substantially the entire length of the metal insert 505. In use, the practitioner is able to pinch the occlusal and gingival sides of the bracket, causing the bottom wall of the bracket to fracture along the recess, greatly simplifying removal of a ceramic bracket base.

FIG. 4B illustrates an alternative embodiment that functions in much the same way, except that a recess 609 is included within the ceramic portion of the bottom wall of ceramic body 604, rather than in the lingual wall 605c of metal insert 605.

FIG. 4C illustrates another alternative embodiment in which recesses 709 are formed in both the lingual wall 705c of metal insert 705 and the bottom wall of ceramic body 704. As seen, the recesses 709 are aligned with one another so as to be in the same buccal-lingual plane.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A convertible orthodontic bracket comprising:
a bracket base including a slot and being formed of a ceramic and/or polymeric material; and
a metal insert received within the slot of the bracket base, the metal insert defining an arch wire hole bounded by a lingual bottom wall, a gingival to sidewall, and an occlusal sidewall of the metal insert, the metal insert further including a removable labial web cover extending between the gingival and occlusal sidewalls over a labial surface of the arch wire hole, wherein the lingual bottom wall, the gingival and occlusal sidewalls, and the removable labial web cover comprise an integral single piece of metal.

2. An orthodontic bracket as recited in claim 1, wherein the bracket base comprises a ceramic.

3. An orthodontic bracket as recited in claim 1, wherein the bracket base comprises a polymeric material.

4. An orthodontic bracket as recited in claim 1, wherein the metal insert comprises at least one of 17-4 or 17-7 class stainless steel.

5. An orthodontic bracket as recited in claim 1, wherein the metal insert is formed by machining.

6. An orthodontic bracket as recited in claim 1, wherein the labial web cover includes:
a first connecting web region of reduced cross-sectional thickness extending between the gingival sidewall on one side of the first connecting web region and a thickened central portion of the labial web cover on an opposite side of the first connecting web region; and
a second connecting web region of reduced cross-sectional thickness extending between the occlusal sidewall on one side of the second connecting web region and the thickened central portion of the labial web cover on an opposite side of the second connecting web region.

7. An orthodontic bracket as recited in claim 6, wherein the first connecting web region is substantially parallel to the second connecting web region.

8. An orthodontic bracket as recited in claim 6, wherein the first connecting web region is formed so as to be substantially in a plane defined by an occlusal edge of the arch wire hole and the second connecting web region is formed so as to be substantially in a plane defined by a gingival edge of the arch wire hole such that, when the labial web cover is removed, no remaining portion of the labial web cover occludes labial access to the arch wire hole.

9. An orthodontic bracket as recited in claim 6, wherein the cross-sectional thickness of each connecting web region is tapered so as to be thinner at a mesial edge and thicker at a distal edge of the labial web cover.

10. An orthodontic bracket as recited in claim 6, further comprising perforations formed through each connecting web region.

11. An orthodontic bracket as recited in claim 1, wherein the bracket further comprises means for mechanically retaining the metal insert within the slot of the bracket base.

12. An orthodontic bracket as recited in claim 11, wherein the means for mechanically retaining the metal insert within the slot of the bracket base comprises:
one or more projections and/or recesses disposed on an exterior surface of at least one of the gingival sidewall, the occlusal sidewall, or the bottom sidewall of the metal insert; and
one or more corresponding mating projections and/or recesses disposed on the interior surface of the slot of the bracket base, the one or more mating projections and/or recesses of the bracket base being configured to receive and/or be received by the projections and/or recesses of the metal insert.

13. An orthodontic bracket as recited in claim 1, wherein the bracket base comprises a ceramic, and further comprising means for facilitating debonding of the orthodontic bracket from a tooth.

14. An orthodontic bracket as recited in claim 13, wherein the means for facilitating debonding of the orthodontic bracket from a tooth comprises a localized line of reduced cross-sectional thickness disposed on the lingual bottom wall of the metal insert.

15. An orthodontic bracket as recited in claim 13, wherein the means for facilitating debonding of the orthodontic bracket from a tooth comprises a localized line of reduced cross-sectional thickness disposed on a bottom wall of the ceramic bracket base.

16. An orthodontic bracket as recited in claim 13, wherein the means for facilitating debonding of the orthodontic bracket from a tooth comprises a first localized line of reduced cross-sectional thickness disposed on a bottom wall of the ceramic bracket base and a second localized line of reduced cross-sectional thickness disposed on the lingual bottom wall of the metal insert.

17. An orthodontic bracket as recited in claim 1, wherein mesial and distal edges of the gingival, occlusal, and lingual side walls of the metal insert are flared to facilitate insertion of an archwire into an entrance of the arch wire hole.

18. A convertible orthodontic bracket comprising:
a bracket base including a slot and being formed of a ceramic and/or polymeric material;
a metal insert received within the slot of the bracket base, the metal insert defining an arch wire hole bounded by a lingual bottom wall, a gingival sidewall, and an occlusal sidewall; and
a removable labial web cover extending between the gingival and occlusal sidewalls over a labial surface of the arch wire hole, the labial web cover further comprising:
a first connecting web region of reduced cross-sectional thickness extending between the gingival sidewall on one side of the first connecting web region and a thickened central portion of the labial web cover on an opposite side of the first connecting web region; and
a second connecting web region of reduced cross-sectional thickness extending between the occlusal sidewall on one side of the second connecting web region and a thickened central portion of the labial web cover on an opposite side of the second connecting web region,
wherein the cross-sectional thickness of each connecting web region is tapered so as to be thinner at a mesial edge and thicker at a distal edge of the labial web cover.

19. An orthodontic bracket as recited in claim 18, further comprising means for mechanically retaining the metal insert within the slot of the bracket base, the means for mechanically retaining comprising:
one or more projections and/or recesses disposed on an exterior surface of at least one of the gingival sidewall, the occlusal sidewall, or the bottom sidewall of the metal insert; and
one or more corresponding mating projections and/or recesses disposed on the interior surface of the slot of the bracket base, the one or more mating projections and/or recesses of the bracket base being configured to receive and/or be received by the projections and/or recesses of the metal insert.

20. A convertible orthodontic bracket comprising:
a bracket base including a slot and being formed of a ceramic material;
a metal insert received within the slot of the bracket base, the metal insert comprising:
a lingual bottom wall;
a gingival sidewall;
an occlusal sidewall; and
a removable labial web cover extending between the gingival and occlusal sidewalls; and
a localized line of reduced cross-sectional thickness disposed on at least one of a bottom wall of the ceramic bracket base or the lingual bottom wall of the metal insert for facilitating debonding of the bracket.
